(19) United States
(12) Patent Application Publication
(10) Pub. No.: US 2026/0067442 A1
(43) Pub. Date: Mar. 5, 2026

(54) SYNCHRONIZATION OF OPTICAL SENSORS FOR REDUCING POWER COMSUMPTION

(71) Applicant: INUITIVE LTD., Ra’anana (IL)

(72) Inventors: Assaf MANDELBLIT, Tel Aviv (IL); Elad REHANY, Pardes Hanna-Karkur (IL)

(21) Appl. No.: 18/825,942

(22) Filed: Sep. 5, 2024

(51) Int. Cl. H04N 13/296; G01J 1/44; H04N 13/243; H04N 25/50; H04N 25/709; H04N 25/78

(52) U.S. Cl. CPC H04N 13/296; G01J 1/44; H04N 13/243; H04N 25/50; H04N 25/709; H04N 25/78; G01J 2001/444

(57) ABSTRACT

A method for power saving of an operating an optical arrangement comprising a plurality of optical sensors, is provided. The method comprises determining frame properties for each of the plurality of optical sensors, based on the frames' properties determined synchronizing their read-out period, upon synchronizing the read-out period of the frames, determining a processing period for each of the optical sensors so that the processing periods at least partially overlap each other, and obtaining at least partially overlapping blank period for all of the plurality of optical sensors. During the at least partially overlapping blank period, powering off modules comprised within the optical arrangement that are not in-use during that period.

### TECHNICAL FIELD

The present disclosure generally relates to methods for using optical devices, and more particularly, to methods that enable reducing power consumption while operating an optical arrangement that comprises a number of camera units.

### BACKGROUND

A stereoscopic camera arrangement is an apparatus made of two camera units, assembled in a stereoscopic module. Stereoscopy is a technique for creating or enhancing the illusion of depth in an image derived from a number of images of the same scene, by means of stereopsis. In other words, it is the impression of depth that is perceived when a scene is viewed with both eyes by someone having normal binocular vision, which is responsible for creating two slightly different images of the scene in the two eyes due to the eyes'/camera's different locations.

In embedded stereoscopic camera arrangements, power budget is always a limiting factor, and hence power consumption saving is an important issue in operating such arrangements.

In computer vision systems that include several camera modules of different sensors types (global shutter, rolling shutter), different camera vendors, different frame rates and different shutter exposure times, the required processing of the captured images by each camera module might be different in both processing duration and timing.

The above factors might lead to the fact that the processing of the input received by the various camera modules is carried out during almost 100% of the system's operating time, and hence is likely to increase power consumption of the operating system.

In order to optimize the processing power consumption in such cases, it is common in the art to use an external trigger for the camera modules, and then, based on the common trigger for the camera modules, to synchronize the operation of these different camera modules. This solution enables reducing the “active processing” time of the captured images and hence enables power saving.

However, in certain cases, various camera modules are not capable of operating in response to such an external trigger and consequently, synchronization between such camera modules becomes problematic.

Thus, the problem which the present invention seeks to solve is how to synchronize different camera modules in order to reduce power consumption of the apparatus comprising these different camera modules, for cases that an external trigger cannot be used for activating some of the different camera modules.

### SUMMARY OF THE DISCLOSURE

The disclosure may be summarized by referring to the appended claims.

It is an object of the present disclosure to provide a method for reducing power consumption of operating vision systems that include several optical sensors.

It is an object of the present disclosure to provide an automated algorithm that is capable of learning frames' properties associated with each of the different optical sensors comprised within an embedded system, and based on the frames' properties learnt, synchronizing their read-out period.

It is an object of the present disclosure to provide a method for determining a delay for various optical sensors in an optical system for maximizing the overlap of the optical sensors' readout period.

Other objects of the present invention will become apparent from the following description.

According to a first embodiment of the present disclosure there is provided a method for power saving of an operating an optical arrangement (e.g., a multi camera modules arrangement) comprising a plurality of optical sensors by determining frame properties for each of the plurality of optical sensors, and based on the frames' properties determined, synchronizing their read-out period. Upon synchronizing the read-out period of the frames, determining a processing period for each of the optical sensors so that the processing periods at least partially overlap each other, and obtaining at least partially overlapping blank period for all of the plurality of optical sensors, and wherein during the at least partially overlapping blank period, powering off modules comprised within said optical arrangement that are not in-use during that period.

In accordance with another embodiment of the disclosure, a method for power saving of an operating an optical arrangement comprising a plurality of optical sensors is provided, wherein at least one of the optical sensors is characterized that it cannot be activated in response to receiving an external triggering signal. The method comprises the steps of:
(i) providing an optical arrangement comprising a plurality of optical sensors, each associated with specific frame properties that include exposure period, read-out period and blank period;
(ii) retrieving by at least one processor comprised in the optical arrangement information that relates to specific frame properties for each of the plurality of optical sensors;
(iii) based on the retrieved information, synchronizing by at least one processor comprised in the optical arrangement the read-out periods for all optical sensors;
(iv) upon synchronizing the read-out periods for all optical sensors, determining by at least one processor comprised in the optical arrangement, at least partially overlapping processing period for frames associated with at least some of the optical sensors;
(v) upon determining the at least partially overlapping processing period for frames associated with at least some of the optical sensors, determining by at least one processor comprised in the optical arrangement, an at least partially overlapping blank period for the at least some of the optical sensors; and
(vi) during that at least partially overlapping blank period, powering off internal modules within the optical arrangement that are not in-use during that at least partially overlapping blank period, thereby obtaining power saving in the operation of the optical arrangement.

According to still another embodiment, step (ii) above further comprises the steps of:
a) defining different combinations of the plurality of optical sensors based on their frame properties, and defining a virtual trigger for each of said different combinations;
b) selecting a master optical sensor for each of the different combinations, whereas all other optical sensors that belong to a specific combination are defined either as slaves, being optical sensors that would be triggered relative to the master optical sensor, or as free running optical sensors;
c) for each of the different combinations, determining a score based on a mechanism for calculating the Frames Per Second (“FPSs”) score for all optical sensors that belong to each of the different combinations; and
d) selecting a combination associated with the lowest score obtained.

Optionally, the mechanism for calculating the Frames Per Second (“FPSs”) score for all optical sensors that belong to each of the different combinations is the greatest common divisor (GCD).

By yet another embodiment step (iii) above further comprises the steps of:
(i) upon selecting the combination associated with the lowest score obtained, triggering the plurality of optical sensors in accordance with the virtual trigger defined for the selected combination;
(ii) collecting time-stamps associated with “end of frame” signals received from the plurality of optical sensors; and
(iii) calculating relative delays required to bring the slave optical sensors end of frame in line with that of the master optical sensor.

According to another embodiment, after applying the relative delays calculated, repeating the method every time an optical sensor is removed from the optical arrangement or added thereto.

### BRIEF DESCRIPTION OF THE DRAWING

For a more complete understanding of the present invention, reference is now following detailed description taken in conjunction with the accompanying drawing wherein:

FIG. 1—demonstrates a flow chart of a method construed in accordance with an embodiment of the present invention for reducing power consumption in an optical arrangement;

FIG. 2—exemplifies a method construed in accordance with an embodiment of the present invention for reducing power consumption of a 3D optical apparatus by combining clock gating with the triggering process of the present disclosure;

FIG. 3—demonstrates an example of an outcome of a step carried out as part of the method according to an embodiment of the present invention, by which common frames are determined by implementing a GCD calculation. The frame rates of the three optical sensors included in this example are 10, 35 and 50 frames per second;

FIG. 4—illustrates an example of a method for calculating the triggering delay; and

FIG. 5—demonstrates an example of implementing an embodiment of the present disclosure for establishing a delay for optical sensors having different frame rates.

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a better understanding of the present invention by way of examples. It should be apparent, however, that the present invention may be practiced without these specific details.

Briefly, the main idea of the present disclosure may be summarized as follows.

A typical frame captured by a camera sensor usually comprises exposure period, read-out period and blank period. The solution proposed by the present disclosure is based on implementing an automated algorithm that is capable of determining the frame properties of each of the different optical sensors comprised within the embedded system (including different exposure that changes over time) and based on the frames' properties determined, synchronizing their read-out period. Once the read-out period is synchronized, the processing period of all camera modules overlap to one extent or another, and hence also their blank periods overlap at some extent. Consequently, during the overlapping blank period, the embedded system can power off internal modules that are not in-use and achieve the required power saving.

Preferably, the present solution relies on receiving an “End of frame” indication. Once an “End of frame” indication is received, it marks the timing at which the full frame was received by the 3D optical apparatus processor, a timing which corresponds to the end of read-out timing.

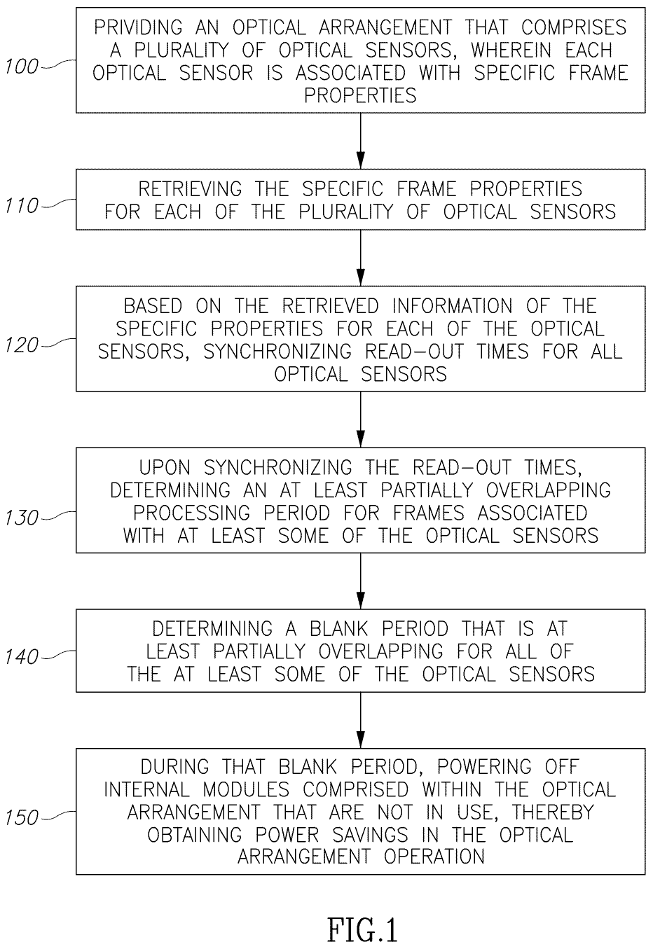

FIG. 1 demonstrates a flow chart of a method construed in accordance with an embodiment of the present invention for reducing power consumption in an optical arrangement.

First, an optical arrangement is provided (step 100) which comprises a plurality of optical sensors (e.g., camera modules), wherein at least one of the optical sensors is characterized that it cannot be activated in response to receiving an external triggering signal, and wherein each of the optical sensors is associated with specific frame properties that include exposure period, read-out period and blank period.

The specific frame properties for each of the plurality of optical sensors are then retrieved (step 110), and based on the retrieved information, synchronizing the read-out periods for all optical sensors (step 120).

Upon synchronizing the read-out periods for all optical determining sensors, at least partially overlapping processing period for frames associated with at least some of the optical sensors (step 130).

upon determining the at least partially overlapping processing period for frames associated with at least some of the optical sensors, determining at least partially overlapping blank period for the at least some of the optical sensors (step 140).

During that at least partially overlapping blank period, powering off internal modules within the optical arrangement that are not in-use during that at least partially overlapping blank period, thereby obtaining power saving in the operation of the optical arrangement (step 150).

Broadly speaking, the method comprises three main stages:
(i) Definition of the triggering scheme;
(ii) Learning and calculation of relative delays; and
(iii) Synchronization of the relevant camera modules.

### Stage I—Definition of a Triggering Scheme:

a) According to the method proposed by the present invention, different combinations of the plurality of camera modules based on the latter frame properties, are defined. For each of these different combinations, a virtual trigger is defined. The term “virtual trigger” as used herein throughout the specification and claims refers to a software timer that is used as a trigger.
b) Next, for each of these different combinations, an “anchor” camera module (a master) is selected, whereas the remaining camera modules that belong to a specific combination are defined by the processor either as camera modules that would be triggered relative to the anchor camera module (slaves) or as free running camera modules.
c) For each of these combinations, determining a score based on a mechanism such as the greatest common divisor (hereinafter: “GCD”) of the different participating Frames Per Second (“FPSs”).
d) Choosing the combination associated with the lowest score.

### Stage II—Learning and Calculation of Relative Delays

a) Upon choosing the combination associated with the lowest score, the processor is configured to cause the different camera modules (optical sensors) to be triggered according definitions of the virtual trigger associated with the selected combination.
b) Next, time-stamps associated with the “end of frame” signals received from the different optical sensors are collected.
c) Then, the relative delays required to bring the “slave camera modules” end of frame to the same timing as that of the master camera module (the anchor camera module), are calculated by the processor for the different slave camera modules.

### Stage III—Synchronization of Relevant Sensors

The delays calculated at the end of stage II are then applied, and the 3D optical apparatus is ready to function in a power saving mode.

Preferably, the process described above is repeated every time a channel/optical sensor is removed from the 3D optical apparatus or added thereto.

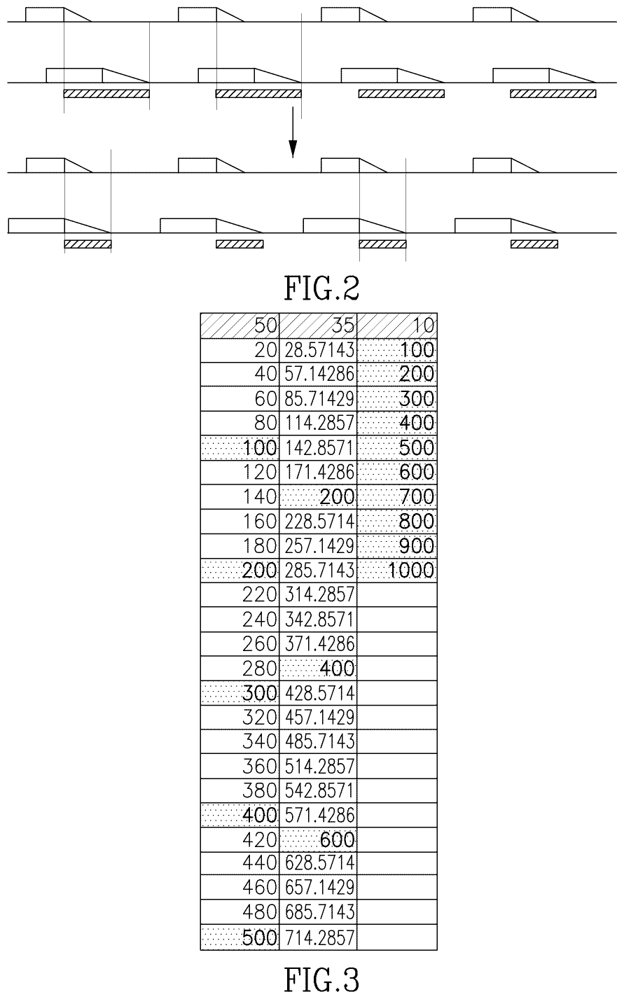

FIG. 2 exemplifies a method construed in accordance with an embodiment of the present invention, for reducing power consumption of a 3D optical apparatus. In accordance with this embodiment, clock gating is combined with the triggering process of the present disclosure.

By using the above-described embodiment process of FIG. 2, one is able to synchronize the optical sensors' start of readout, and thereby reduce the time period when the HW clock is on, as may be seen from FIG. 2, and consequently reducing the power used.

As may be seen in this FIG. 2, the “ON” time is the total duration of all read-outs. In the upper part of the figure illustrates a case where the starts of the read out of the different optical sensor are not synchronized, hence the duration of the “ON” time is larger, whereas in the bottom part of the figure, once the start of the readout is synchronized between all optical sensors, even if their exposure times are different, still, due to the overlapping of the read-out times, their total “ON” time is reduced.

The synchronization of the operation of the various optical sensors can be made automatically by tagging all optical sensors that will take part in the process to establish the common virtual trigger, while other optical sensors can still be triggered manually while still other optical sensors can be left out from the triggering process.

### Adding/Removing a Channel/Optical Sensor

The adding or removal of a channel/optical sensor may be carried out as follows:

Upon determining the possible combinations of the plurality of camera modules based on their frame properties, establishing a common virtual trigger for all optical sensors that belong to a certain combination, and selecting an anchor optical sensor for this combination, determining if the selected optical sensor is trigger support or not.

### Example 1—Selecting a Virtual Trigger for Optical Sensors Comprised in a 3D Optical Apparatus

Let us consider an example of an arrangement that comprises 3 optical sensors, 2 of which do not support a triggering mode while the third does. The following illustrates a method for selecting a combination of two optical sensors.

The first step in this process is to score each possible combination as part of the process of selecting the best combination:

$$score = ( {\sum }_{i = 0}^{n} frame rate ) - ( {\sum }_{i = 0}^{n} {GCD ( {FPS}_{A} , {FPS}_{B} )}_{all combinations without repetition} ) + GCD ( all , if n > 2 )$$

### Where:

n—the number of optical sensors participating in the specific combination for which the score is being calculated;
GCD—Greatest Common Divisor;
For optical sensors not participating in the combination—adding their frames; Next, the combination of optical sensors associated with a lowest score is selected.

The method described herein may also take into account the duration of the readout period and which Imaging Depth and Vision Engine (“IDVE”) HW's are used by each optical channel, and what is the power consumption by each of these HW's.

FIG. 3 demonstrates an example of an outcome of a step carried out as part of the method according to an embodiment of the present invention, by which common frames are determined by implementing a GCD calculation. The frame rates of the three optical sensors included in this example are 10, 35 and 50 frames per second.

As may be seen in this figure, the GCD result of scoring the combination of the 50 and 30 frames per second optical sensor is:

$$GCD ( 50 , 30 ) = 5$$

which leads to using a common frame of 200 milliseconds.

Whereas, the GCD result of scoring the combination of the 50 and 30 frames per second optical sensor is:

$$GCD ( 50 , 10 ) = 10$$

which leads to using a common frame of 100 milliseconds.

Upon selecting the lowest score combination, there are a number of options.

I) First, if the optical sensor selected as an anchor for the selected combination, supports a triggering mode a software timer is determined as a virtual trigger for the group of optical sensors.

In this case, another optical sensor that belongs to the combination supports a triggering mode, determining an additional software timer to be a trigger, whereas another optical sensor in this case which does not support a triggering mode, determining that the optical sensor as a free running sensor.

II) In case that the optical sensor selected as an anchor for the selected combination, does not support a triggering mode, the anchor sensor is set as a free running sensor, whereas for the other optical sensors, the anchor Sensor Link Unit (“SLU”) which is responsible for synchronizing the input sensor data to the system's clock domain and converting the pixels to a common format is selected as the triggering source.

III) In case that none of the optical sensors included in the group support a triggering mode, all optical sensors that belong to this group are determined as free running sensors.

When a software timer is used as a triggering source, the present invention preferably further comprises a step of determining its repetition rate, while each optical sensor would be triggered according to its FPS/LCM, where LCM, Least Common Multiple, also known as the lowest common multiple of two (or more) integers a and b, is the smallest positive integer that is divisible by both.

Next, the following embodiment provides a method determining the delay for the various optical sensors as retrieved from the anchoring optical sensor, in order to maximize the overlap that will exist at the sensors' readout period. Preferably, according to this embodiment the following steps are taken:
(i) Initializing the optical apparatus operation by using a known (e.g., previously obtained) trigger configuration;
(ii) collecting time stamps from all optical sensors at start-of-frame interrupt, until a plurality (e.g., at least 4) of samples is obtained from each optical sensor;
(iii) Calculating the delay between each of the optical sensors and the known trigger configuration;
(iv) Applying a forced delay to the optical sensor serving as the anchor optical sensor; and
(v) Restarting the optical apparatus operation while using the updated forced delay.

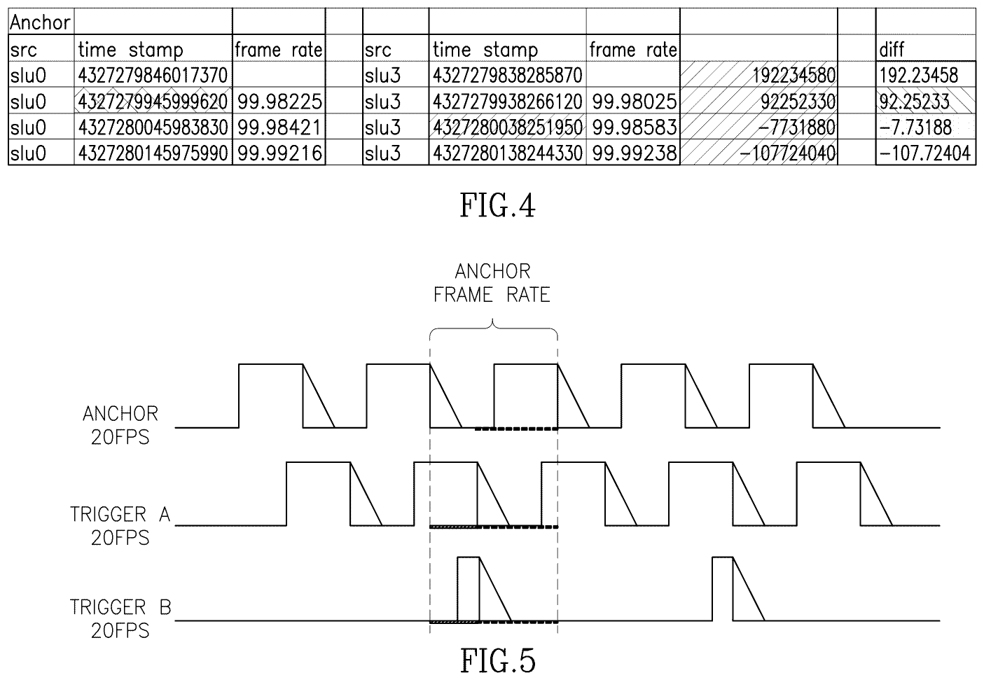

FIG. 4 illustrates an example of a method for calculating the triggering delay, having the steps of taking the time stamp of the anchor optical sensor, finding the nearest time stamp to the anchor optical sensor by calculating the differences between the various time stamps and that of the anchor optical sensor, and determining the delay which is equal to the difference between the time stamps.

FIG. 5 demonstrates an example of implementing the method provided by the present disclosure where the anchor optical sensor has a rate of 20 frames per second (“FPS”), and the other two optical sensors, A and B, of this example have a rate of 20 FPS and 10 FPS, respectively. As may be seen from this FIG., even though optical sensor A and B have different frame rate, still, by applying the solution provided by the present invention, optical sensors A and B have the same delay, which eventually enables reducing the power consumption of the optical apparatus comprising the exemplified optical sensors.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A method for power saving of an operating an optical arrangement comprising a plurality of optical sensors by determining frame properties for each of said plurality of optical sensors, and based on the frames' properties determined, synchronizing their read-out period, upon synchronizing the read-out period of the frames, determining a processing period for each of the optical sensors so that the processing periods at least partially overlap each other, and obtaining at least partially overlapping blank period for all of said plurality of optical sensors, and wherein during said at least partially overlapping blank period, powering off modules comprised within said optical arrangement that are not in-use during that period.

2. A method for power saving of an operating an optical arrangement comprising a plurality of optical sensors, wherein at least one of the optical sensors is characterized that it cannot be activated in response to receiving an external triggering signal, wherein the method comprises the steps of:
(i) providing an optical arrangement comprising a plurality of optical sensors, each associated with specific frame properties that include exposure period, read-out period and blank period;
(ii) retrieving by at least one processor comprised in the optical arrangement information that relates to specific frame properties for each of the plurality of optical sensors;
(iii) based on the retrieved information, synchronizing by at least one processor comprised in the optical arrangement the read-out periods for all optical sensors;
(iv) upon synchronizing the read-out periods for all optical sensors, determining by at least one processor comprised in the optical arrangement, at least partially overlapping processing period for frames associated with at least some of the optical sensors;
(v) upon determining the at least partially overlapping processing period for frames associated with at least some of the optical sensors, determining by at least one processor comprised in the optical arrangement, an at least partially overlapping blank period for the at least some of the optical sensors; and
(vi) during that at least partially overlapping blank period, powering off internal modules within the optical arrangement that are not in-use during that at least partially overlapping blank period, thereby obtaining power saving in the operation of the optical arrangement.

3. The method of claim 2, wherein step (ii) further comprises the steps of:
a) defining different combinations of the plurality of optical sensors based on their frame properties, and defining a virtual trigger for each of said different combinations;
b) selecting a master optical sensor for each of said different combinations, whereas all other optical sensors that belong to a specific combination are defined either as slaves, being optical sensors that would be triggered relative to the master optical sensor, or as free running optical sensors;
c) for each of said different combinations, determining a score based on a mechanism for calculating the Frames Per Second (“FPSs”) score for all optical sensors that belong to each of the different combinations; and
d) selecting a combination associated with the lowest score obtained.

4. The method of claim 3, wherein the mechanism for calculating the Frames Per Second (“FPSs”) score for all optical sensors that belong to each of the different combinations is the greatest common divisor (GCD).

5. The method of claim 3, wherein step (iii) further comprises the steps of:
(i) upon selecting the combination associated with the lowest score obtained, triggering said plurality of optical sensors in accordance with the virtual trigger defined for the selected combination;
(ii) collecting time-stamps associated with “end of frame” signals received from said plurality of optical sensors; and
(iii) calculating relative delays required to bring the slave optical sensors end of frame in line with that of the master optical sensor.

6. The method of claim 5, wherein after applying the relative delays calculated, repeating the method every time an optical sensor is removed from the optical arrangement or added thereto.
